(19) United States
(12) Patent Application Publication
(10) Pub. No.: US 2018/0366255 A1
(43) Pub. Date: Dec. 20, 2018

(54) COIL COMPONENT AND MANUFACTURING METHOD THEREFOR

(71) Applicant: TDK CORPORATION, TOKYO (JP)

(72) Inventors: Tasuku MIKOGAMI, TOKYO (JP); Nobuo TAKAGI, TOKYO (JP)

(73) Assignee: TDK CORPORATION, TOKYO (JP)

(21) Appl. No.: 16/007,238

(22) Filed: Jun. 13, 2018

(30) Foreign Application Priority Data
Jun. 15, 2017 (JP) 2017-117631

(51) Int. Cl. H01F 27/28; H01F 27/24; H01F 27/29; H01F 41/064; H01F 41/10

(52) U.S. Cl. CPC H01F 27/2823; H01F 27/24; H01F 41/10; H01F 41/064; H01F 27/29

(57) ABSTRACT

Disclosed herein is a coil component that includes a drum core having a winding core part and a first flange part, and first to fourth wires wound around the winding core part. One ends of the wires are each connected to any one of the terminal electrodes provided on the first flange part. The first to fourth wires wound around the winding core part form a winding block including a lower layer constituted of the first and third wires and an upper layer constituted of the second and fourth wires wound over the lower layer. A distance between connection positions of one ends of the first and third wires and an outside surface of the first flange part is shorter than a distance between connection positions of one ends of the second and fourth wires and the outside surface of the first flange part.

### BACKGROUND OF THE INVENTION

### Field of the Invention

The present invention relates to a coil component and a circuit board provided with the same and, more particularly, to a coil component using a drum core and a circuit board provided with the same. The present invention also relates to a manufacturing method for the coil component using a drum core.

### Description of Related Art

As a surface-mount type coil component using a drum core, there are known coil components described in JP 2010-109267 A and JP 2015-201613 A. In both JP 2010-109267 A and JP 2015-201613 A, the coil component has one and the other ends thereof each having three terminal electrodes and four wires. One ends of four wires are each connected to any one of the three terminal electrodes provided in the one end, and the other ends of the four wires are each connected to any one of the three terminal electrodes provided in the other end.

In the coil components described in JP 2010-109267 A and JP 2015-201613 A, first, two of the four wires are wound around a winding core part to forma lower winding layer, and then the remaining two wires are wound over the lower winding layer to form an upper winding layer.

However, the wires constituting the lower winding layer directly contact the winding core part and are thus applied with stress particularly at a portion where they are bent at the corner of the winding core part, which may cause disconnection of the wire or damage to an insulation coating on the wire.

### SUMMARY

It is therefore an object of the present invention to provide a coil component capable of preventing wire disconnection or wire damage caused due to contact between the wires constituting the lower winding layer and a winding core part and a manufacturing method for the coil component.

A coil component according to the present invention includes: a drum core including a winding core part, a first flange part provided at one end of the winding core part in the axial direction thereof, and a second flange part provided at the other end of the winding core part in the axial direction thereof; a plurality of terminal electrodes provided on each of the first and second flange parts; and, first, second, third, and fourth wires wound around the winding core part. One ends of the first to fourth wires are each connected to any one of the plurality of terminal electrodes provided on the first flange part, and the other ends of the first to fourth wires are each connected to any one of the plurality of terminal electrodes formed on the second flange part. A winding block constituted of the first to fourth wires wound around the winding core part includes a lower layer constituted of the first and third wires and an upper layer constituted of the second and fourth wires wound over the lower layer. The first and second flange parts each have an inside surface connected to the winding core part and an outside surface positioned on the side opposite to the inside surface. The connection positions of the one ends of the first and third wires are closer to the outside surface of the first flange part than the connection positions of the one ends of the second and fourth wires are.

According to the present invention, the connection positions of one ends of the first and third wires are shifted to the side of the outside surface of the first flange part, so that stress caused due to contact between the first and third wires constituting the lower winding layer and the winding core part can be relieved. This can prevent wire disconnection or wire damage.

In the present invention, first and third wire connection parts constituting the respective one ends of the first and third wires and second and fourth wire connection parts constituting the respective one ends of the second and fourth wires need not overlap each other in the axial direction. With this configuration, it is possible to effectively prevent damage and deterioration in solder wettability due to excessive heat history.

In the present invention, the connection positions of the other ends of the first and third wires may be closer to the outside surface of the second flange part than the connection positions of the other ends of the second and fourth wires, or the distance between the connection positions of the other ends of the first to fourth wires and the outside surface of the second flange part may be equal to each other. In the latter case, a space formed between the inside surface of the first flange part and the winding block may be narrower than a space formed between the inside surface of the second flange part and the winding block. With the above configuration, stress applied to the wire winding start portion which is subjected to large stress can be relieved.

In the present invention, the cross section of the winding core part that is perpendicular to the axial direction has a polygonal shape whose corners are chamfered. The winding core part has a first end region positioned on the first flange part side, a second end region positioned on the second flange part side, and a center region positioned between the first and second end regions. The chamfered radius at the first and second end regions may be smaller than the chamfered radius at the center region. With the above configuration, stress applied to the wires at the end region having a small chamfered radius can be relieved.

In the present invention, the plurality of terminal electrodes provided on the first flange part may include first, second, and third terminal electrodes arranged in this order in a direction perpendicular to the axial direction, the plurality of terminal electrodes provided on the second flange part may include fourth, fifth, and sixth terminal electrodes arranged in this order in a direction perpendicular to the axial direction, one end of the first wire may be connected to one of the first and second terminal electrodes, one end of the second wire may be connected to the other one of the first and second terminal electrodes, the other ends of the first and second wires may be connected to the fourth terminal electrode, one ends of the third and fourth wires may be connected to the third terminal electrode, the other end of the third wire may be connected to one of the fifth and sixth terminal electrodes, the other end of the fourth wire may be connected to the other one of the fifth and sixth terminal electrodes, and the first and third wires and the second and fourth wires may be wound in opposite directions. With the above confirmation, a pulse transformer having a six-terminal configuration can be constituted.

In the present invention, the plurality of terminal electrodes provided on the first flange part may include first, second, third, and fourth terminal electrodes arranged in this order in a direction perpendicular to the axial direction, the plurality of terminal electrodes provided on the second flange part may include, fifth, sixth, seventh, and eighth terminal electrodes arranged in this order in a direction perpendicular to the axial direction, one end of the first wire may be connected to one of the first and second terminal electrodes, the other end of the first wire may be connected to one of the fifth and sixth terminal electrodes, one end of the second wire may be connected to the other one of the first and second terminal electrodes, the other end of the second wire may be connected to the other one of the fifth and sixth terminal electrodes, one end of the third wire may be connected to one of the third and fourth terminal electrodes, the other end of the third wire may be connected to one of the seventh and eighth terminal electrodes, one end of the fourth wire may be connected to the other one of the third and fourth terminal electrodes, the other end of the fourth wire may be connected to the other one of the seventh and eighth terminal electrodes, and the first and third wires and the second and fourth wires may be wound in opposite directions. With the above confirmation, a pulse transformer having an eight-terminal configuration can be constituted.

A coil component manufacturing method according to the present invention includes: preparing a drum core including a winding core part, a first flange part provided at one end of the winding core part in the axial direction thereof, and a second flange part provided at the other end of the winding core part in the axial direction thereof; forming a plurality of terminal electrodes on each of the first and second flange parts; winding the first and third wires around the winding core part of the drum core in a state where one ends of the first and third wires are each connected to any one of the plurality of terminal electrodes provided on the first flange part and connecting the other ends of the first and third wires each to any one of the plurality of terminal electrodes provided on the second flange part; and winding the second and fourth wires around the winding core part of the drum core in a state where one ends of the second and fourth wires are each connected to any one of the plurality of terminal electrodes provided on the first flange part and connecting the other ends of the second and fourth wires each to any one of the plurality of terminal electrodes provided on the second flange part. The first and second flange parts each have an inside surface connected to the winding core part and an outside surface positioned on the side opposite to the inside surface. The connection positions of the one ends of the first and third wires are closer to the outside surface of the first flange part than the connection positions of the one ends of the second and fourth wires are.

According to the present invention, it is possible to manufacture a coil component while preventing wire disconnection or wire damage caused due to contact between the winding core part and the first and third wires constituting the lower winding layer.

In the present invention, the step of connecting one ends of the first and third wires each to any one of the plurality of terminal electrodes provided on the first flange part includes a first thermal press fitting process of performing thermal press-fitting of the first and third wires using a heating head after positioning one ends of the first and third wires each on any one of the plurality of terminal electrodes provided on the first flange part, and the step of connecting one ends of the second and fourth wires each to any one of the plurality of terminal electrodes provided on the first flange part includes a second thermal press fitting process of performing thermal press fitting of the second and fourth wires using a heating head after positioning one ends of the second and fourth wires each on any one of the plurality of terminal electrodes provided on the first flange part. The position of the heating head in the axial direction in the first thermal press fitting process may be closer to the outside surface of the first flange part than the position of the heating head in the axial direction in the second thermal press fitting process is. With this configuration, heat applied to the one ends of the first and third wires can be alleviated when the one ends of the second and fourth wires are thermally press-fitted.

In the present invention, in the second thermal press fitting process, the thermal press fitting may be performed so as not to allow the heating head to contact the one ends of the first and third wires. With this configuration, heat is hardly applied to the one ends of the first and third wires when the one ends of the second and fourth wires are thermally press-fitted.

Thus, according to the present invention, there can be provided a coil component capable of preventing wire disconnection or wire damage caused due to contact between the wires constituting the lower winding layer and the winding core part and a manufacturing method for the coil component.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a schematic perspective view illustrating the outer appearance of a coil component according to a first embodiment of the present invention;

FIG. 2 is an equivalent circuit diagram of the coil component shown in FIG. 1;

FIGS. 3 to 6 are schematic plan views for explaining a manufacturing method for the coil component according to the first embodiment of the present invention;

FIG. 7 is a schematic perspective view for explaining the configuration of the drum core;

FIG. 8 is a schematic diagram for explaining an effect obtained by shifting the connection positions;

FIG. 9 is a schematic perspective view illustrating the outer appearance of a coil component according to a second embodiment of the present invention;

FIG. 10 is a plan view of the coil component according to the second embodiment of the present invention;

FIG. 11 is a schematic perspective view illustrating the outer appearance of a coil component according to a third embodiment of the present invention;

FIG. 12 is a plan view of the coil component according to a modification of the third embodiment of the present invention;

FIG. 13 is a schematic perspective view illustrating the outer appearance of a coil component according to a fourth embodiment of the present invention; and

FIG. 14 is a plan view of the coil component according to a modification of the fourth embodiment of the present invention.

### DETAILED DESCRIPTION OF THE EMBODIMENTS

Preferred embodiments of the present invention will now be explained in detail with reference to the drawings.

### First Embodiment

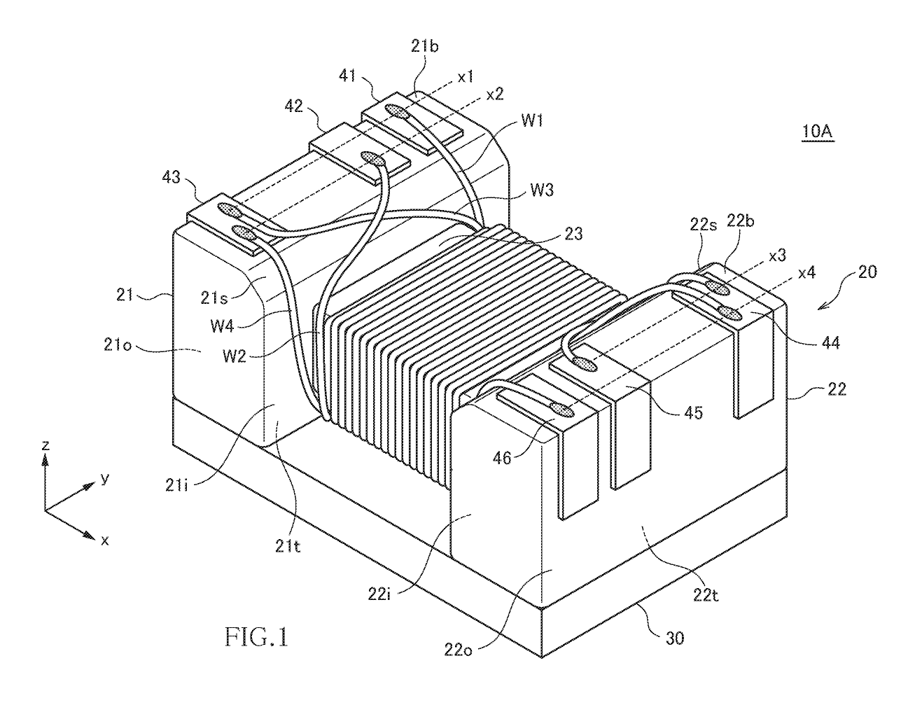

FIG. 1 is a schematic perspective view illustrating the outer appearance of a coil component 10A according to the first embodiment of the present invention.

The coil component 10A according to the present embodiment is a pulse transformer and has a drum core 20, a plate-like core 30, six terminal electrodes 41 to 46, and four wires W1 to W4, as illustrated in FIG. 1.

The drum core 20 includes a winding core part 23, a first flange part 21 provided at one end of the winding core part 23 in the axial direction (x-direction), and a second flange part 22 provided at the other end of the winding core part 23 in the axial direction. The drum core 20 is a block made of a high permeability material such as ferrite and has a configuration in which the flange parts 21 and 22 and winding core part 23 are formed integrally. While the yz cross section (cross section perpendicular to the axial direction) of the winding core part 23 has a rectangular shape, the corners thereof are chamfered by barrel polishing. The cross section of the winding core part 23 need not necessarily be rectangular but may have other shapes, e.g., a polygonal shape other than a rectangle, such as a hexagon or an octagon. Further, the winding core part 23 may partially have a curved surface.

The first flange part 21 has an inside surface 21i connected to the winding core part 23, an outside surface 21o positioned on the side opposite to the inside surface 21i, a bottom surface 21b facing a substrate at mounting, and a top surface 21t positioned on the side opposite to the bottom surface 21b. The inside surface 21i and the outside surface 21o each constitute the yz plane, and the bottom surface 21b and top surface 21t each constitute the xy plane. Similarly, the second flange part 22 has an inside surface 22i connected to the winding core part 23, an outside surface 22o positioned on the opposite side to the inside surface 22i, a bottom surface 22b facing the substrate at mounting, and a top surface 22t positioned on the side opposite to the bottom surface 22b. The inside surface 22i and the outside surface 22o each constitute the yz plane, and the bottom surface 22b and the top surface 22t each constitute the xy plane. In the present embodiment, the corner between the bottom surface 21b and the inside surface 21i of the first flange part 21 is chamfered to have a slope 21s. Similarly, the corner between the bottom surface 22b and the inside surface 22i of the second flange part 22 is chamfered to have a slope 22s.

The plate-like core 30 is bonded to the top surface 21t of the first flange part 21 and the top surface 22t of the second flange part 22. The plate-like core 30 is a plate-like member made of a high permeability material such as ferrite and constitutes a closed magnetic path together with the drum core 20. The plate-like core 30 may be made of the same material as that of the drum core 20.

As illustrated in FIG. 1, the three terminal electrodes 41 to 43 are provided on the first flange part 21. The terminal electrodes 41 to 43 are arranged in this order in the y-direction and each have an L-like shape that covers the bottom surface 21b and the outside surface 21o. The first terminal electrode 41 is connected with one end of the first wire W1, the second terminal electrode 42 is connected with one end of the second wire W2, and the third terminal electrode 43 is connected with one ends of the third and fourth wires W3 and W4 in common.

Similarly, the three terminal electrodes 44 to 46 are provided on the second flange part 22. The terminal electrodes 44 to 46 are arranged in this order in the y-direction and each have an L-like shape that covers the bottom surface 22b and the outside surface 22o. The fourth terminal electrode 44 is connected with the other ends of the first and second wires W1 and W2 in common, the fifth terminal electrode 45 is connected with the other end of the fourth wire W4, and the sixth terminal electrode 46 is connected with the other end of the third wire W3.

The terminal electrodes 41 to 46 may each be a terminal metal fitting bonded to the drum core 20 or may each be directly formed on the drum core 20 using a conductive paste.

The first and third wires W1 and W3 and the second and fourth wires W2 and W4 are wound in opposite directions. Thus, as illustrated in the circuit diagram of FIG. 2, a pulse transformer is constituted, in which the first and second terminal electrodes 41 and 42 function as a pair of primary-side terminals, the fifth and sixth terminal electrodes 45 and 46 function as a pair of secondary-side terminals, the fourth terminal electrode 44 functions as a primary-side center tap, and the third terminal electrode 43 function as a secondary-side center tap. Here, the primary side and the secondary side are defined conveniently, and they may be reversed.

The first and second terminal electrodes 41 and 42 constituting the pair of primary-side terminals are terminals that receive or output a pair of differential signals. The connection relationship between the first and second terminal electrodes 41 and 42 and the first and second wires W1 and W2 is not limited to that illustrated in FIGS. 1 and 2 and may be reversed. Similarly, the fifth and sixth terminal electrodes 45 and 46 constituting the pair of secondary-side terminals are terminals to receive or output a pair of differential signals. The connection relationship between the fifth and sixth terminal electrodes 45 and 46 and the third and fourth wires W3 and W4 is not limited to that illustrated in FIGS. 1 and 2 and may be reversed.

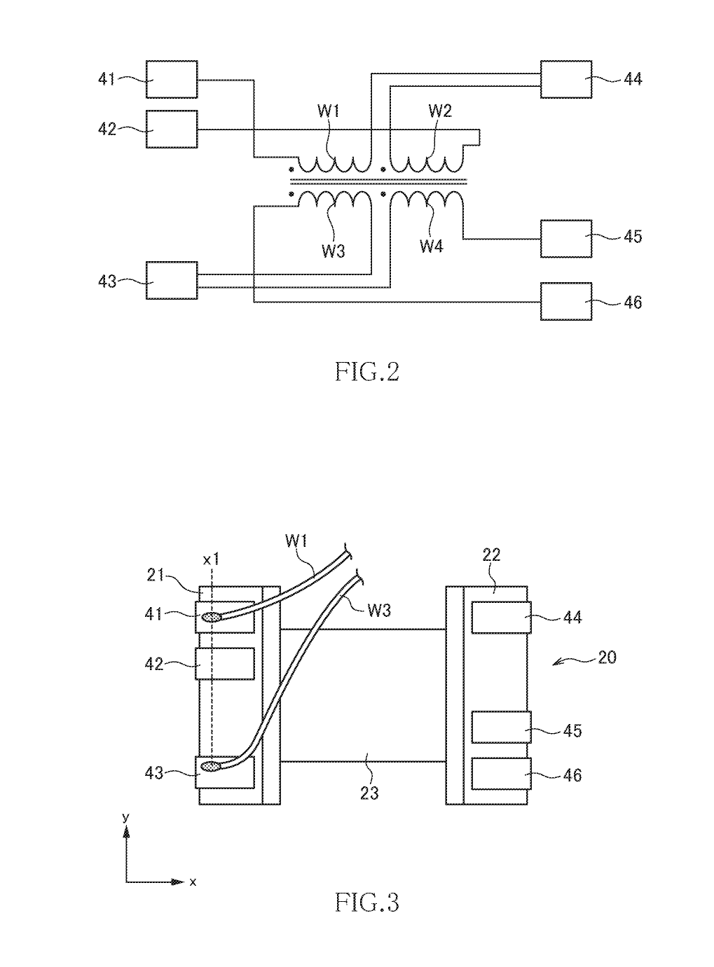

FIGS. 3 to 6 are schematic plan views for explaining a manufacturing method for the coil component 10A according to the present embodiment.

First, the drum core 20 is prepared, and the terminal electrodes 41 to 43 and terminal electrodes 44 to 46 are formed on the first flange part 21 and the second flange part 22, respectively. Then, as illustrated in FIG. 3, one end of the first wire W1 is connected to the first terminal electrode 41, and one end of the third wire W3 is connected to the third terminal electrode 43. Specifically, the first and third wires w1 and W3 are disposed on the first and third terminal electrodes 41 and 43, respectively, and then a heating head is pressed against the first and third wires W1 and W3, whereby the first and third wires W1 and W3 are thermally press-fitted to the first and third terminal electrodes 41 and 43, respectively. The connection positions of one ends of the first and third wires W1 and W3 in the x-direction are each x1 and shifted to the side of the outside surface 21o of the first flange part 21. In this state, the drum core 20 is rotated in one direction to wind the first and third wires W1 and W3 around the winding core part 23 of the drum core 20. Upon starting the winding, the drum core 20 needs to be rotated in a state where the first and third wires W1 and W3 are tensed enough to be kept from slacking off. Thus, the winding start portions of the first and third wires W1 and W3 are bent at the corner portion of the winding core part 23 and applied with stress at this portion.

After that, the first and third wires W1 and W3 are wound around the winding core part 23 by a predetermined number of turns. Then, as illustrated in FIG. 4, the other end of the first wire W1 is connected to the fourth terminal electrode 44, and the other end of the third wire W3 is connected to the sixth terminal electrode 46. A connection method used here is the above-mentioned thermal press fitting. The connection positions of the other ends of the first and third wires W1 and W3 in the x-direction are each x4 and shifted to the side of the outside surface 22o of the second flange part 22. Thus, winding of the first and third wires W1 and W3 is completed, whereby a winding layer (lower winding layer) constituted by the first and third wires W1 and W3 is formed on the winding core part 23. At this time, the lower winding layer is preferably offset to the first flange part 21 side.

In other words, the first and third wires W1 and W3 are preferably wound such that a space S1 formed between the inside surface 21i of the first flange part 21 and the lower winding layer is narrower than a space S2 formed between the inside surface 22i of the second flange part 22 and the lower winding layer. This is because when the space S1 formed on the first flange part 21 side which is the winding start side is made narrow, the space S2 formed on the second flange part 22 side which is the winding end side can be made wide, so that it is possible to sufficiently ensure a margin for winding work.

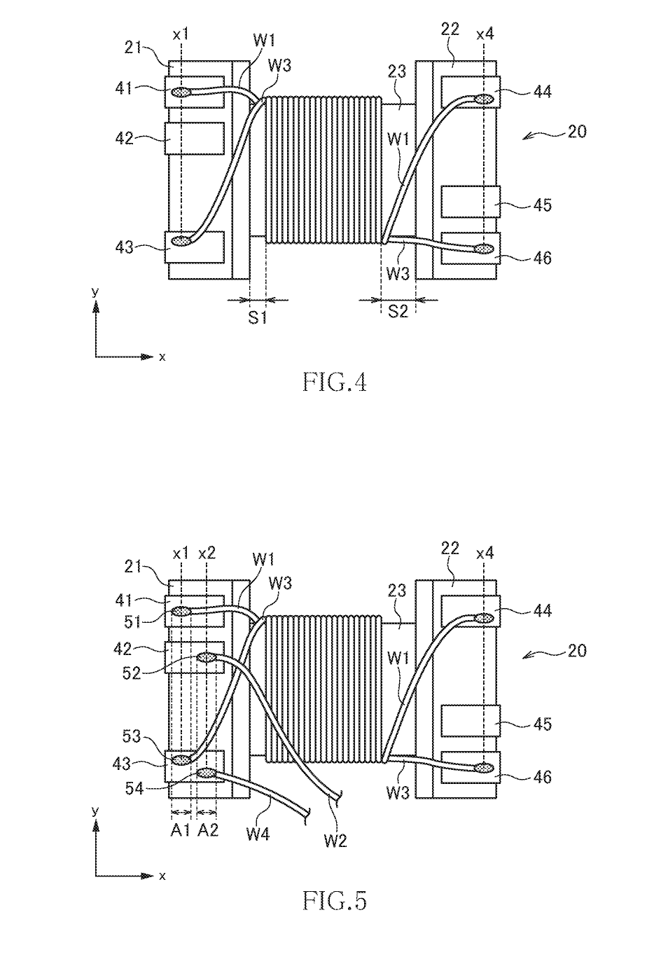

Then, as illustrated in FIG. 5, one end of the second wire W2 is connected to the second terminal electrode 42, and one end of the fourth wire W4 is connected to the third terminal electrode 43. A connection method used here is the above-mentioned thermal press fitting. The connection positions of one ends of the second and fourth wires W2 and W4 in the x-direction are each x2 and shifted to the side of the inside surface 21i of the first flange part 21. That is, the connection position x1 is closer to the side of the outside surface 21o of the first flange part 21 than the connection position x2 is. The wire connection at the connection positions x1 and x2 can be controlled by controlling the position of the heating head in the x-direction. That is, when one ends of the first and third wires W1 and W3 are connected at the connection position x1, the heating head is offset to the side of the outside surface 21o of the first flange part 21, while when one ends of the second and fourth wires W2 and W4 are connected at the connection position x2, the heating head is offset to the side of the inside surface 21i of the first flange part 21. When one ends of the second and fourth wires W2 and W4 are connected at the connection position x2, it is possible to prevent the heating head from contacting one ends of the first and third wires W1 and W3. In this case, wire connection parts 51 and 53 constituting the respective one ends of the first and third wires W1 and W3 and wire connection parts 52 and 54 constituting the respective one ends of the second and fourth wires W2 and W4 do not overlap each other in the x-direction. That is, an area A1 corresponding to the length of each of the wire connection parts 51 and 53 in the x-direction and an area A2 corresponding to the length of each of the wire connection parts 52 and 54 in the x-direction do not overlap each other. With this configuration, it is possible to prevent the one ends of the first and third wires W1 and W3 from being heated twice.

In this state, the drum core 20 is rotated in the reverse direction to wind the second and fourth wires W2 and W4 around the winding core part 23 of the drum core 20. Upon starting the winding, the drum core 20 needs to be rotated in a state where the second and fourth wires W2 and W4 are pulled so as to prevent the second and fourth wires W2 and W4 from being loosened.

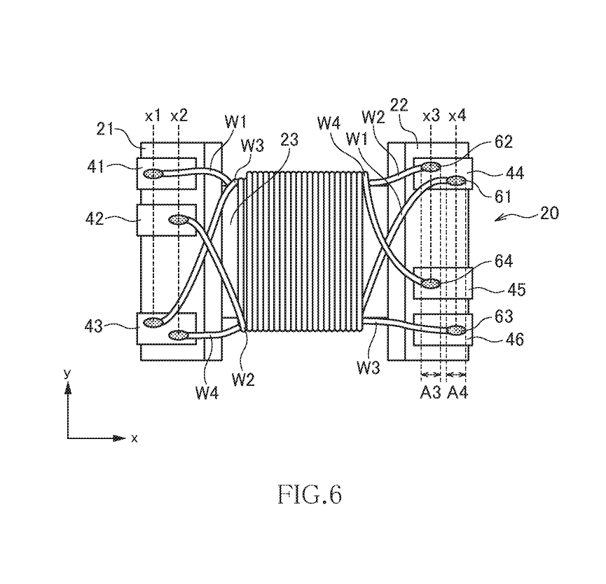

After that, the second and fourth wires W2 and W4 are wound around the winding core part 23 by a predetermined number of turns. Then, as illustrated in FIG. 6, the other end of the second wire W2 is connected to the fourth terminal electrode 44, and the other end of the fourth wire W4 is connected to the fifth terminal electrode 45. A connection method used here is the above-mentioned thermal press fitting. The connection positions of the other ends of the second and fourth wires W2 and W4 in the x-direction are each x3 and shifted to the side of the inside surface 22i of the second flange part 22. That is, the connection position x4 is closer to the side of the outside surface 22o of the second flange part 22 than the connection position x3 is. The wire connection at the connection positions x3 and x4 can be controlled by controlling the position of the heating head in the x-direction. That is, when the other ends of the first and third wires W1 and W3 are connected at the connection position x4, the heating head is offset to the side of the outside surface 22o of the second flange part 22, while when the other ends of the second and fourth wires W2 and W4 are connected at the connection position x3, the heating head is offset to the side of the inside surface 22i of the second flange part 22. When the other ends of the second and fourth wires W2 and W4 are connected at the connection position x3, it is possible to prevent the heating head from contacting the other ends of the first and third wires W1 and W3. In this case, wire connection parts 61 and 63 constituting the respective other ends of the first and third wires W1 and W3 and wire connection parts 62 and 64 constituting the respective other ends of the second and fourth wires W2 and W4 do not overlap each other in the x-direction. That is, an area A4 corresponding to the length of each of the wire connection parts 61 and 63 in the x-direction and an area A3 corresponding to the length of each of the wire connection parts 62 and 64 in the x-direction do not overlap each other. With this configuration, it is possible to prevent the other ends of the first and third wires W1 and W3 from being heated twice.

Thus, winding of the second and fourth wires W2 and W4 is completed, whereby a winding layer (upper winding layer) constituted by the second and fourth wires W2 and W4 is formed on the lower winding layer constituted by the first and third wires W1 and W3. The upper winding layer is also preferably offset to the first flange part 21 side for the same reason as described above. That is, a winding block constituted by the upper and lower winding layers is preferably offset as a whole to the first flange part 21 side.

Then, the plate-like core 30 is bonded to the top surfaces 21t and 22t of the flange parts 21 and 22, whereby the coil component 10A according to the present embodiment is completed.

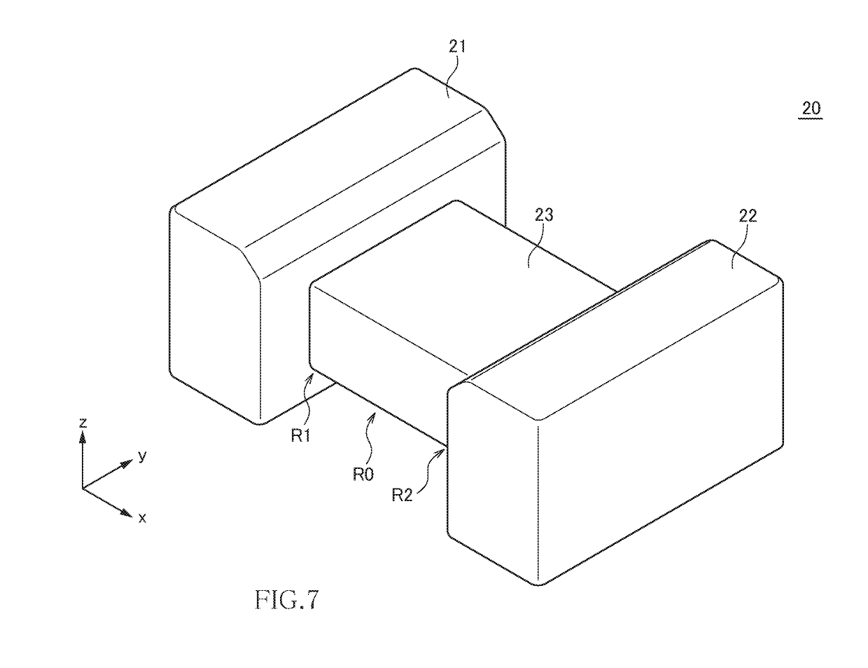

FIG. 7 is a schematic perspective view for explaining the configuration of the drum core 20.

As illustrated in FIG. 7, all the corner portions of the drum core 20 are chamfered and each have a predetermined chamfered radius. Such chamfering is performed by barrel polishing. However, the drum core 20 has a complicated shape and has therefore a portion (corner) easily chamfered and a portion (corner) hardly chamfered, and at the portion hardly chamfered, the chamfered radius may be reduced. Specifically, in the winding core part 23, a first end region R1 near the inside surface 21i of the first flange part 21 and a second end region R2 near the inside surface 22i of the second flange part 22 are hardly chamfered due to the existence of the flange parts 21 and 22.

Thus, although the winding core part 23 has a rectangular shape as a whole whose corners are chamfered in the yz cross section (cross section perpendicular to the axial direction), the chamfered radius at the first and second end regions R1 and R2 may be smaller than the chamfered radius at a center region R0 positioned between the first and second end regions R1 and R2. In such a case, stress applied to the wires W1 and W3 of the lower winding layer directly contacting the winding core part 23 tends to be large at the first and second end regions R1 and R2. In particular, since the first end region R1 is positioned on the winding start side, the space S1 (see FIG. 4) formed between the inside surface 21i of the first flange part 21 and the lower winding layer is set narrow, and the wires W1 and W3 are pulled comparatively strongly at the start of winding. Thus, large stress is applied to the first and third wires W1 and W3 contacting the corner portion of the first end region R1.

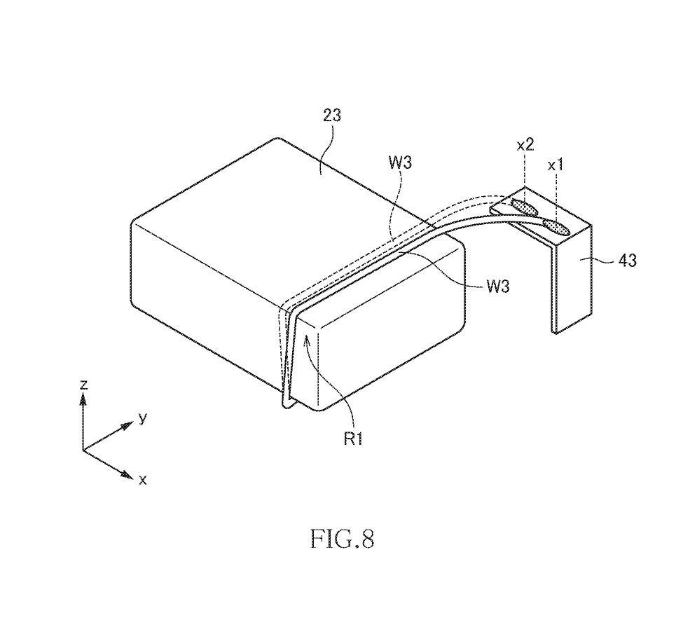

Considering the above point, in the coil component 10A according to the present embodiment, the connection positions x1 of one ends of the respective first and third wires W1 and W3 are shifted to the outside surface 21o side for stress relaxation, and the connection positions x4 of the other ends of the respective first and third wires W1 and W3 are shifted to the outside surface 22o side for stress relaxation. A mechanism for stress relaxation due to the shifting of the connection position is as follows. That is, as illustrated in FIG. 8 which is a schematic perspective view, a comparison is made between a case where the third wire W3 is connected at the connection position x1 (position near the outside surface 21o) and a case where the third wire W3 is connected at the connection position x2 (position near the inside surface 21i). In this case, since the connection position x1 is shifted to the outside surface 21o side, the bending angle of the third wire W3 at the corner portion of the first end region R1 becomes gentler when the third wire W3 is connected at the connection position x1 than when connected at the connection position x2. Thus, stress to be applied to the third wire W3 at the corner portion of the first end region R1 is relieved. When the connection positions of one ends of the first and third wires W1 and W3 are shifted to the outside surface 21o side based on such a mechanism, stress to be applied to the first and third wires W1 and W3 caused due to contact with the corner portion of the first end region R1 is relieved. As a result, disconnection of the wires W1 and W3 or damage to the insulation coating thereof is prevented, thus making it possible to further enhance the reliability of the product.

On the other hand, the second and fourth wires W2 and W4 constitute the upper winding layer do not basically directly contact the winding core part 23, so that such stress as that applied to the first and third wires W1 and W3 does not occur. Thus, the connection positions of the second and fourth wires W2 and W4 are not shifted to the outside surfaces 21o and 22o side, but the second and fourth wires W2 and W4 are connected at the connection positions x2 and x3 near the inside surfaces 21i and 22i.

However, when the wire connection position is shifted to the outside surface 21o side, a CuNi alloy generated by the thermal press fitting is formed on the vertical part of the terminal electrode, i.e., apart of the terminal electrode that extends in the z-direction while covering the outside surface 21o or a part near it, with the result that solder wettability at this part may be deteriorated. When solder wettability at this part is deteriorated, a solder filet is hardly formed when the coil component 10A is mounted on the substrate, which may deteriorate connection reliability in some cases. Considering this point, in the coil component 10A according to the present embodiment, while one and the other ends of the first and third wires W1 and W3 are shifted to the outside surface 21o or 22o side, one and the other ends of the second and fourth wires W2 and W4 are not shifted but connected at positions separated from the vertical part of the terminal electrode, thereby minimizing a possibility that the connection reliability is deteriorated.

In particular, when a configuration is adopted, where the wire connection parts 51 and 53 and the wire connection parts 52 and 54 do not overlap each other in the x-direction and where the wire connection parts 61 and 63 and the wire connection parts 62 and 64 do not overlap each other in the x-direction, the wire connection parts 51, 53, 61, and 63 can be prevented from being subjected to thermal press fitting twice, thus making it possible to effectively prevent damage and deterioration in solder wettability due to excessive heat history.

As described above, in the coil component 10A according to the present embodiment, the connection positions x1 and x4 of the first and third wires W1 and W3 constituting the lower winding layer are shifted to the outside surface side, so that stress caused due to contact between the first and third wires W1 and W3 and the winding core part 23 can be relieved. In addition, the connection positions x2 and x3 of the second and fourth wires W2 and W4 constituting the upper winding layer is shifted to the inside surface side, so that solder wettability at mounting can be ensured.

### Second Embodiment

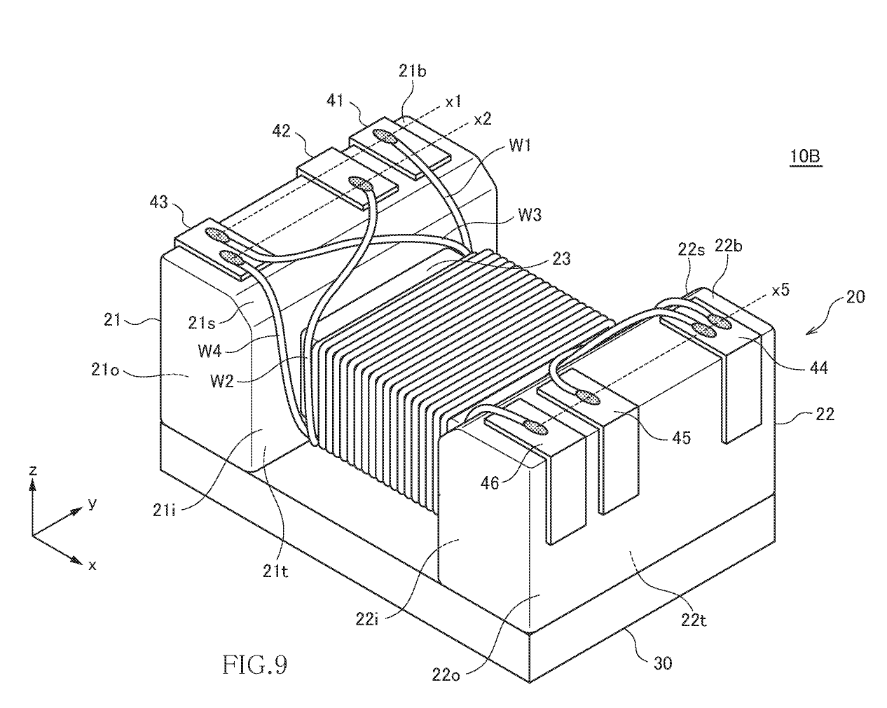

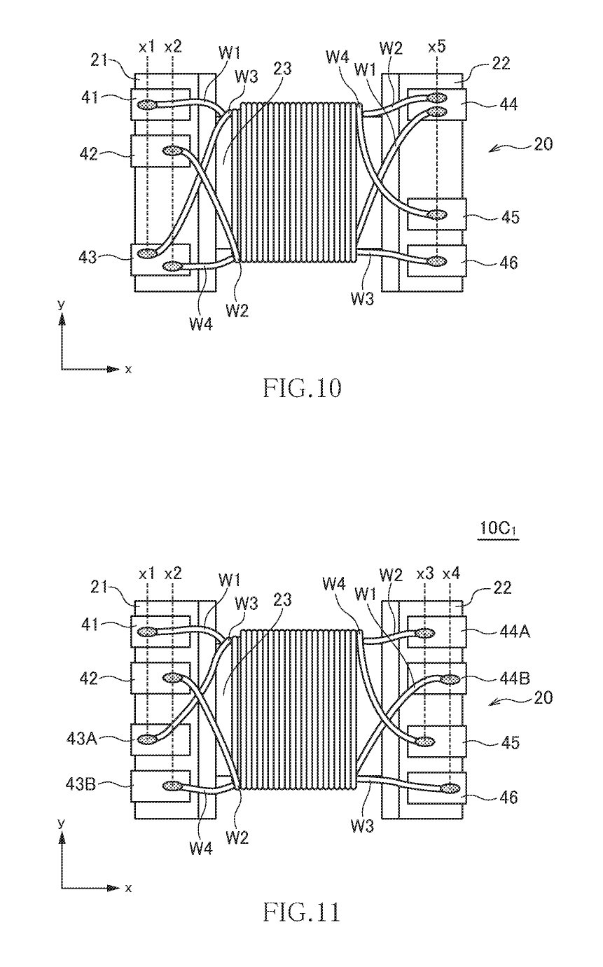

FIG. 9 is a schematic perspective view illustrating the outer appearance of a coil component 10B according to the second embodiment of the present invention. FIG. 10 is a plan view of the coil component 10B according to the second embodiment.

As illustrated in FIGS. 9 and 10, the coil component 10B according to the present embodiment differs from the coil component 10A according to the first embodiment in that all the other ends of the first to fourth wires W1 to W4 are connected at a connection position x5. The connection position x5 is set at substantially the center of the terminal electrodes 44 to 46 in the x-direction and is located between the connection positions x3 and x4. Other configurations are the same as those of the coil component 10A according to the first embodiment, so the same reference numerals are given to the same elements, and overlapping description will be omitted.

As described above, the space S2 (see FIG. 4) formed between the inside surface 22i of the second flange part 22 and the lower winding layer tends to become wider than the space S1, so that there may be a case where the winding ends of the first and third wires W1 and W3 do not contact the second end region R2. In such a case, stress applied to the winding ends of the first and third wires W1 and W3 is not so large, so that when all the other ends of the first to fourth wires W1 to W4 are connected at the connection position x5 as in the present embodiment, deterioration in solder wettability at mounting can be minimized.

However, the space S2 undergoes a greater size change due to manufacturing variations than the space S1, so that the winding ends of the first and third wires W1 and W3 may contact the corner portion of the second end region R2 in some manufacturing condition, causing damage to the first and third wires W1 and W3 at the contact portion. To cope with such a problem, the connection positions x4 of the other ends of the first and third wires W1 and W3 are preferably shifted to the outside surface side as in the coil component 10A according to the first embodiment.

### Third Embodiment

FIG. 11 is a plan view of a coil component 10C1 according to the third embodiment of the present invention.

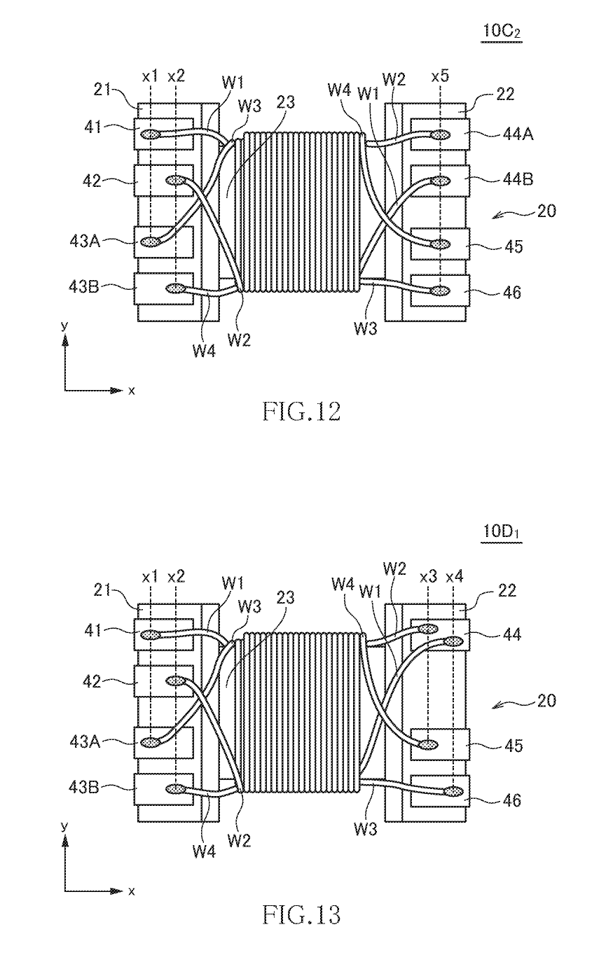

As illustrated in FIG. 11, in the coil component 10C1 according to the present embodiment, the third terminal electrode 43 is divided into two terminal electrodes 43A and 43B, and the fourth terminal electrode 44 is divided into two terminal electrodes 44A and 44B. One ends of the third and fourth wires W3 and W4 are connected respectively to the terminal electrodes 43A and 43B, and the other ends of the second and first wires W2 and W1 are connected respectively to the terminal electrodes 44A and 44B. Other configurations are the same as those of the coil component 10A according to the first embodiment, so the same reference numerals are given to the same elements, and overlapping description will be omitted. While illustration of the plate-like core 30 is omitted in FIG. 11, it is preferable to provide the plate-like core 30 as is the case in the first and second embodiments, and the same applies to FIGS. 12 to 14.

The terminal electrodes 43A and 43B constitute a secondary-side center tap and are short-circuited on a circuit board on which the coil component 10C1 is mounted. The terminal electrodes 44A and 44B constitute a primary-side center tap and are short-circuited on the circuit board on which the coil component 10C1 is mounted. As a result, the same circuit configuration as that of the coil component 10A according to the first embodiment can be obtained. The connection relationship between the terminal electrodes 43A, 43B and the wires W3, W4 may be inverted. Similarly, the connection relationship between the terminal electrodes 44A, 44B and the wires W2, W1 may be inverted.

As exemplified in the present embodiment, in the present invention, the number of the terminal electrodes to be formed on each of the first and second flange parts 21 and 22 need not necessarily be three and may be four. Further, all the other ends of the first to fourth wires W1 to W4 may be connected at the connection position x5 as in a coil component C₂ according to a modification illustrated in FIG. 12. An effect obtained by this configuration is as described in relation to the coil component 10B according to the second embodiment.

### Fourth Embodiment

FIG. 13 is a plan view of a coil component 10D1 according to the fourth embodiment according to the present invention.

As illustrated in FIG. 13, in the coil component 10D1 according to the present embodiment, the third terminal electrode 43 is divided into two terminal electrodes 43A and 43B, and one ends of the third and fourth wires W3 and W4 are connected respectively to the terminal electrodes 43A and 43B. Other configurations are the same as those of the coil component 10A according to the first embodiment, so the same reference numerals are given to the same elements, and overlapping description will be omitted.

The terminal electrodes 43A and 43B constitute a secondary-side center tap and are short-circuited on a circuit board on which the coil component 10D1 is mounted. As a result, the same circuit configuration as that of the coil component 10A according to the first embodiment can be obtained. The connection relationship between the terminal electrodes 43A, 43B and the wires W3, W4 may be inverted.

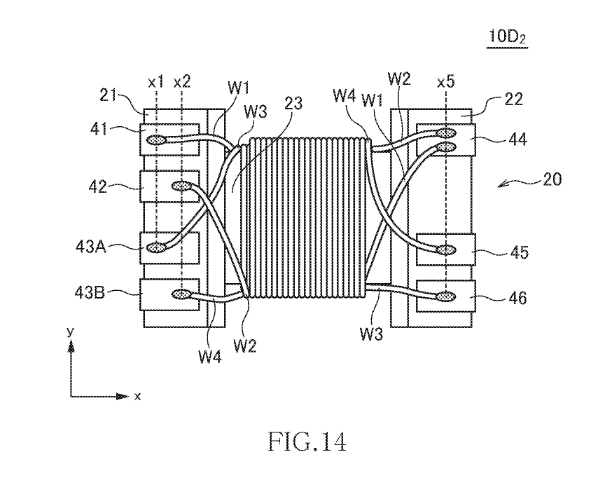

As exemplified in the present embodiment, in the present invention, the number of the terminal electrodes to be formed on the first flange part 21 and the number of terminal electrodes to be formed on the second flange part 22 need not necessarily be the same and may differ. Further, all the other ends of the first to fourth wires W1 to W4 may be connected at the connection position x5 as in a coil component D2 according to a modification illustrated in FIG. 14. An effect obtained by this configuration is as described in relation to the coil component 10B according to the second embodiment.

It is apparent that the present invention is not limited to the above embodiments, but may be modified and changed without departing from the scope and spirit of the invention.

What is claimed is:

1. A coil component comprising:
a drum core including a winding core part, a first flange part provided at one end of the winding core part in an axial direction of the winding core part, and a second flange part provided at other end of the winding core part in the axial direction of the winding core part;
a plurality of terminal electrodes provided on each of the first and second flange parts; and
first, second, third, and fourth wires wound around the winding core part,
wherein one ends of the first to fourth wires are each connected to any one of the plurality of terminal electrodes provided on the first flange part,
wherein other ends of the first to fourth wires are each connected to any one of the plurality of terminal electrodes formed on the second flange part,
wherein the first to fourth wires wound around the winding core part form a winding block including a lower layer constituted of the first and third wires and an upper layer constituted of the second and fourth wires wound over the lower layer,
wherein each of the first and second flange parts has an inside surface connected to the winding core part and an outside surface positioned on a side opposite to the inside surface, and
wherein a distance between connection positions of the one ends of the first and third wires and the outside surface of the first flange part is shorter than a distance between connection positions of the one ends of the second and fourth wires and the outside surface of the first flange part.

2. The coil component as claimed in claim 1,
wherein the one ends of the first and third wires form first and third wire connection parts, respectively,
wherein the one ends of the second and fourth wires form second and fourth wire connection parts, respectively, and
wherein the first and third wire connection parts and the second and fourth wire connection parts do not overlap each other in the axial direction.

3. The coil component as claimed in claim 1, wherein a distance between connection positions of the other ends of the first and third wires and the outside surface of the second flange part is shorter than a distance between connection positions of the other ends of the second and fourth wires and the outside surface of the second flange part.

4. The coil component as claimed in claim 1, wherein a distance between connection positions of the other ends of the first and third wires and the outside surface of the second flange part is substantially a same as a distance between connection positions of the other ends of the second and fourth wires and the outside surface of the second flange part.

5. The coil component as claimed in claim 4, wherein a space formed between the inside surface of the first flange part and the winding block is narrower than a space formed between the inside surface of the second flange part and the winding block.

6. The coil component as claimed in claim 1,
wherein a cross section of the winding core part that is perpendicular to the axial direction has a polygonal shape whose corners are chamfered,
wherein the winding core part has a first end region positioned on the first flange part side, a second end region positioned on the second flange part side, and a center region positioned between the first and second end regions, and
wherein a chamfered radius at the first and second end regions is smaller than a chamfered radius at the center region.

7. The coil component as claimed in claim 1,
wherein the plurality of terminal electrodes provided on the first flange part include first, second, and third terminal electrodes arranged in this order in a direction substantially perpendicular to the axial direction,
wherein the plurality of terminal electrodes provided on the second flange part include fourth, fifth, and sixth terminal electrodes arranged in this order in the direction substantially perpendicular to the axial direction,
wherein the one end of the first wire is connected to one of the first and second terminal electrodes, the one end of the second wire is connected to other one of the first and second terminal electrodes, the other ends of the first and second wires are connected in common to the fourth terminal electrode, the one ends of the third and fourth wires are connected in common to the third terminal electrode, the other end of the third wire is connected to one of the fifth and sixth terminal electrodes, and the other end of the fourth wire is connected to other one of the fifth and sixth terminal electrodes, and
wherein the first and third wires and the second and fourth wires are wound in opposite directions.

8. The coil component as claimed in claim 1,
wherein the plurality of terminal electrodes provided on the first flange part include first, second, third, and fourth terminal electrodes arranged in this order in a direction substantially perpendicular to the axial direction,
wherein the plurality of terminal electrodes provided on the second flange part include, fifth, sixth, seventh, and eighth terminal electrodes arranged in this order in the direction substantially perpendicular to the axial direction,
wherein the one end of the first wire is connected to one of the first and second terminal electrodes, the other end of the first wire is connected to one of the fifth and sixth terminal electrodes, the one end of the second wire is connected to other one of the first and second terminal electrodes, the other end of the second wire is connected to other one of the fifth and sixth terminal electrodes, the one end of the third wire is connected to one of the third and fourth terminal electrodes, the other end of the third wire is connected to one of the seventh and eighth terminal electrodes, the one end of the fourth wire is connected to other one of the third and fourth terminal electrodes, and the other end of the fourth wire is connected to other one of the seventh and eighth terminal electrodes, and
wherein the first and third wires and the second and fourth wires are be wound in opposite directions.

9. A method for manufacturing a coil component, the method comprising:
preparing a drum core including a winding core part, a first flange part provided at one end of the winding core part in an axial direction of the winding core part, and a second flange part provided at other end of the winding core part in the axial direction of the winding core part;
forming a plurality of terminal electrodes on each of the first and second flange parts;
winding the first and third wires around the winding core part of the drum core in a state where one ends of the first and third wires are each connected to any one of the plurality of terminal electrodes provided on the first flange part and thereafter connecting other ends of the first and third wires each to any one of the plurality of terminal electrodes provided on the second flange part; and
winding the second and fourth wires around the winding core part of the drum core in a state where one ends of the second and fourth wires are each connected to any one of the plurality of terminal electrodes provided on the first flange part and thereafter connecting other ends of the second and fourth wires each to any one of the plurality of terminal electrodes provided on the second flange part,
wherein each of the first and second flange parts has an inside surface connected to the winding core part and an outside surface positioned on a side opposite to the inside surface, and
wherein a distance between connection positions of the one ends of the first and third wires and the outside surface of the first flange part is shorter than a distance between connection positions of the one ends of the second and fourth wires and the outside surface of the first flange part.

10. The method for manufacturing a coil component as claimed in claim 9,
wherein the one ends of the first and third wires are each connected to any one of the plurality of terminal electrodes provided on the first flange part by a first thermal press fitting process of performing thermal press-fitting of the first and third wires using a heating head after positioning each of the first and third wires on any one of the plurality of terminal electrodes provided on the first flange part,
wherein the one ends of the second and fourth wires are each connected to any one of the plurality of terminal electrodes provided on the first flange part by a second thermal press fitting process of performing thermal press fitting of the second and fourth wires using the heating head after positioning each of the second and fourth wires on any one of the plurality of terminal electrodes provided on the first flange part, and
wherein a distance between a position of the heating head in the first thermal press fitting process and the outside surface of the first flange part is shorter than a distance between a position of the heating head in the second thermal press fitting process and the outside surface of the first flange part.

11. The method for manufacturing a coil component as claimed in claim 10, wherein the second thermal press fitting process is performed so as not to allow the heating head to contact the one ends of the first and third wires.

12. A coil component comprising:
a drum core including a winding core part and a flange part provided at one end of the winding core part in an axial direction of the winding core part;
a plurality of terminal electrodes provided on the flange part; and
first, second, third, and fourth wires wound around the winding core part,
wherein one ends of the first to fourth wires are each connected to any one of the plurality of terminal electrodes provided on the flange part, and
wherein a position of the one ends of the first and third wires in the axial direction is different from a position of the one ends of the second and fourth wires in the axial direction.

13. The coil component as claimed in claim 12, wherein the first and third wires and the second and fourth wires are wound in opposite directions.

14. The coil component as claimed in claim 13, wherein the first to fourth wires wound around the winding core part form a winding block including a lower layer constituted of the first and third wires and an upper layer constituted of the second and fourth wires wound over the lower layer.

15. The coil component as claimed in claim 12, wherein the third and fourth wires are connected in common to a predetermined one of terminal electrodes.
